(19) United States
(12) Patent Application Publication
(10) Pub. No.: US 2024/0062567 A1
(43) Pub. Date: Feb. 22, 2024

(54) Learning Image Generation Apparatus, Learning Image Generation Method, And Non-Transitory Computer-Readable Recording Medium

(71) Applicant: Konica Minolta, Inc., Tokyo (JP)

(72) Inventor: Takumi KASEDA, Matsudi-shi (JP)

(73) Assignee: Konica Minolta, Inc., Tokyo (JP)

(21) Appl. No.: 18/363,181

(22) Filed: Aug. 1, 2023

(30) Foreign Application Priority Data
Aug. 18, 2022 (JP) 2022-130421

(51) Int. Cl. G06V 30/19; G06T 11/60; G06T 11/00

(52) U.S. Cl. CPC G06V 30/19147; G06T 11/60; G06T 11/001; G06T 2210/62

(57) ABSTRACT

A learning image generation apparatus 5 includes a first image generating unit 21 that receives the known character string Dt and generates a first image G1 including the character string Dt, a second image generating unit 22 that generates a second image G2 to be combined with the first image G1, an image combining unit 23 that generates a learning image G3 by combining the first image G1 and the second image G2, and an outputting unit 24 that outputs the learning image G3 and correct answer data Da of the character string Dt.

This application claims priority to Japanese Patent Application No. 2022-130421 filed on Aug. 18, 2022, the entire contents of which is incorporated herein by reference.

### BACKGROUND

### Technical Field

The present invention relates to a learning image generation apparatus, a learning image generation method, and a non-transitory computer-readable recording medium. In particular, the present invention relates to a technique for generating a learning image for improving character recognition accuracy by artificial intelligence (AI).

### Description of Related Art

In recent years, there have been increasing needs to read a paper document with a scanner or the like, convert the paper document into electronic data, and store the electronic data. When a paper document is converted into electronic data, converting a character string included in the paper document into text data improves the convenience of the paper document converted into electronic data. Conventionally, as one of methods for converting a character string into text data, there is optical character recognition/reader (OCR). That is, an image region in which a character string appears is cut out from an image read by a scanner, and character recognition processing is performed on the image region to convert the character string included in the image into text data.

However, in the conventional character recognition processing, when a ruled line or a frame line is included in the cut-out image region, the portion of the ruled line or the frame line may be erroneously recognized as a character such as “I”, “L”, or “1”, or when there is a seal impression or show-through of a character string, the character of the portion may be erroneously recognized. In order to prevent such erroneous recognition, it is conceivable to perform image processing for erasing ruled lines and frame lines as preprocessing for performing character recognition processing. However, when such image processing is performed, there is a possibility that characters such as “I”, “L”, or “1” which should be originally recognized as characters are deleted, and there is a problem that the characters are not accurately recognized in the subsequent character recognition processing.

On the other hand, in recent years, a technology for recognizing an image using an artificial intelligence (AI) technology has been proposed (Patent Literature 1: JP 2021-111101 A). In this related art, in a case where there is a bias in learning data in a learning data set used for machine learning of AI, the accuracy at the time of image recognition is improved by performing machine learning by updating the learning data set with a reduced bias by 3DCG.

The character recognition processing based on AI can also be applied to the case of recognizing character strings from an image obtained by reading a paper document with a scanner or the like. In the character recognition by the AI, a learning image in which a ruled line, a frame line, a seal impression, or the like is captured is subjected to machine learning in advance, and thus a character string can be recognized by being appropriately separated from image components such as the ruled line, the frame line, and the seal impression. Therefore, it is possible to improve character recognition accuracy without performing preprocessing of the character recognition processing.

However, in order to further increase a character recognition accuracy in the character recognition processing by AI, a large number of learning images including ruled lines, frame lines, seal impressions, and the like used for machine learning are required. It takes a lot of time and effort to prepare such a large number of learning images.

In addition, if the robustness of AI is low, the character recognition accuracy may decrease when unknown noise is mixed. For example, character strings included in an image read by a scanner or the like are described in various fonts (characters), sizes, thicknesses, and densities. Furthermore, a character string may be handwritten. Furthermore, the character string may be inclined in the image. Therefore, in order to ensure robustness in the character recognition process using AI, it is desirable to appropriately recognize the various character strings.

### SUMMARY

The present invention is intended to solve the above-mentioned conventional problems. That is, the present invention makes it possible to easily prepare a large number of learning images in order to improve character recognition accuracy using AI. An object of the present invention is to provide such a learning image generation device, a learning image generation method, and a non-transitory computer-readable recording medium.

First, the present invention is directed to a learning image generation apparatus.

In order to achieve the above object, the learning image generation apparatus according to one aspect of the present invention comprises: a first image generating unit configured to receive a known character string and generate a first image including the character string; a second image generating unit configured to generate a second image to be combined with the first image; an image combining unit configured to combine the first image and the second image to generate a learning image; and an outputting unit configured to output the learning image and correct answer data of the character string.

Second, the present invention is also directed to a learning image generation method.

According to another aspect of the present invention, the learning image generation method comprises: inputting a known character string; generating a first image including the character string; generating a second image to be combined with the first image; generating a learning image by combining the first image and the second image; and outputting the learning image and a correct answer data of the character string.

Third, the present invention is also directed to a non-transitory computer-readable recording medium storing a computer-readable program to be executed by a hardware processor in a computer.

According to still another aspect of the present invention, the non-transitory computer-readable recording medium storing the computer-readable program causing the hardware processor to execute processing including: inputting a known character string; generating a first image including the character string; generating a second image to be combined with the first image; generating a learning image by combining the first image and the second image; and outputting the learning image and a correct answer data of the character string.

### BRIEF DESCRIPTION OF THE DRAWINGS

The advantages and features provided by one or more embodiments of the invention will become more fully understood from the detailed description given herein below and the appended drawings which are given by way of illustration only, and thus are not intended as a definition of the limits of the present invention.

FIG. 1 is a diagram illustrating a configuration example of a character recognition system;

FIG. 2 is a diagram illustrating a hardware configuration of the information processing apparatus;

FIG. 3 is a block diagram illustrating the functional configurations of a learning image generation apparatus and an image processing apparatus;

FIG. 4A is a diagram illustrating an example of combining a second image including a seal impression image with a first image;

FIG. 4B is a diagram illustrating an example of combining a second image including a seal impression image with a first image;

FIG. 4C is a diagram illustrating an example of combining a second image including a seal impression image with a first image;

FIG. 5A is a diagram illustrating a case where the combining position of the second image with respect to the first image is changed;

FIG. 5B is a diagram illustrating a case where the combining position of the second image with respect to the first image is changed;

FIG. 5C is a diagram illustrating a case where the combining position of the second image with respect to the first image is changed;

FIG. 6 is a diagram illustrating an example of generating M learning images from M first images;

FIG. 7A is a diagram illustrating learning images generated by the second image including a ruled line;

FIG. 7B is a diagram illustrating learning images generated by the second image including a ruled line;

FIG. 7C is a diagram illustrating learning images generated by the second image including a ruled line;

FIG. 8A is a diagram illustrating an example of the learning image generated by the second image including the frame line;

FIG. 8B is a diagram illustrating an example of the learning image generated by the second image including the frame line;

FIG. 8C is a diagram illustrating an example of the learning image generated by the second image including the frame line;

FIG. 9A is a diagram illustrating an example of the learning image generated by the second image including the frame line;

FIG. 9B is a diagram illustrating an example of the learning image generated by the second image including the frame line;

FIG. 9C is a diagram illustrating an example of the learning image generated by the second image including the frame line;

FIG. 10A is a diagram illustrating learning images generated by the second image including a character string;

FIG. 10B is a diagram illustrating learning images generated by the second image including a character string;

FIG. 10C is a diagram illustrating learning images generated by the second image including a character string;

FIG. 11A is a diagram illustrating an example of the learning image generated by the second image including the plain image;

FIG. 11B is a diagram illustrating an example of the learning image generated by the second image including the plain image;

FIG. 11C is a diagram illustrating an example of the learning image generated by the second image including the plain image;

FIG. 12 is a diagram illustrating an example of a second image including an imprint image and a plain image;

FIG. 13 is a flowchart illustrating an example of a main processing procedure performed in the learning image generation apparatus;

FIG. 14 is a flowchart illustrating an example of a detailed processing procedure of a first image generation process;

FIG. 15 is a flowchart illustrating an example of a detailed processing procedure of the second image generation process; and

FIG. 16 is a flowchart illustrating an example of a detailed processing procedure of the image combining process.

### DETAILED DESCRIPTION OF EMBODIMENTS

Hereinafter, one or more embodiments of the present invention will be described with reference to the drawings. However, the scope of the invention is not limited to the disclosed embodiments.

Preferred embodiments of the present invention will be described in detail with reference to the drawings. Elements common to each other in the embodiments described below are denoted by the same reference numerals, and redundant description thereof will be omitted.

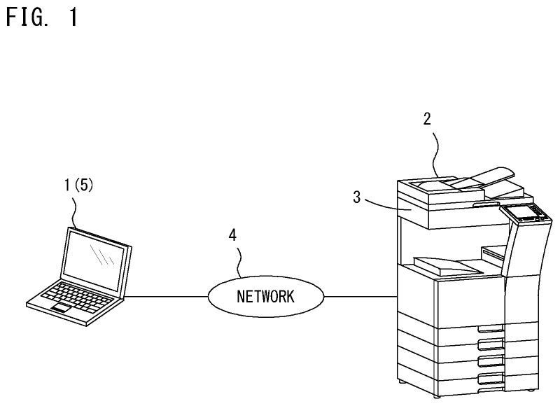

FIG. 1 is a diagram showing an example of a configuration of a character recognition system according to an embodiment of the present invention. This character recognition system is a system that detects a character string included in an image by character recognition processing using AI. The character recognition system includes an information processing apparatus 1 such as a personal computer and an image processing apparatus 2 such as a multifunction peripheral (MFP). The information processing apparatus 1 and the image processing apparatus 2 can communicate with each other via a network 4.

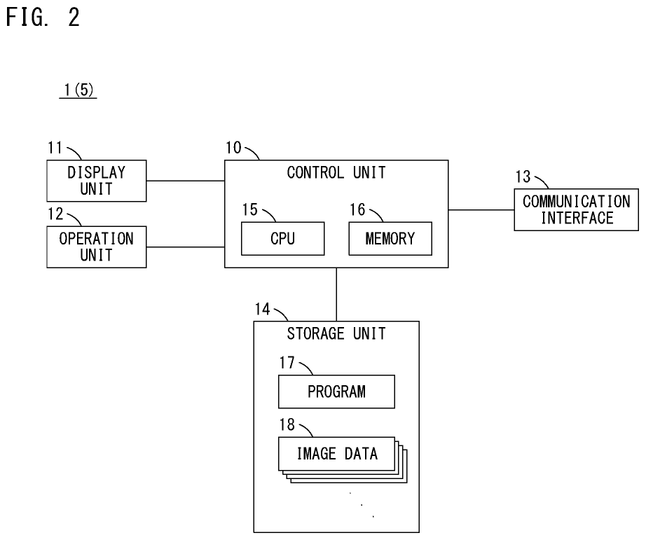

The information processing apparatus 1 functions as a learning image generation apparatus 5 by executing a program 17 described later. FIG. 2 is a diagram illustrating a hardware configuration of the information processing apparatus 1. As shown in FIG. 2, the information processing apparatus 1 includes a control unit 10, a display unit 11, an operation unit 12, a communication interface 13, and a storage unit 14.

The control unit 10 includes a CPU 15 and a memory 16. The control unit 10 controls operations of respective components. CPU 15 is a hardware processor that executes the program 17 stored in the storage unit 14. The memory 16 is a volatile storage device that temporarily stores images and data generated as the CPU 15 executes the program 17. The CPU 15 performs various processes to be described later by using the memory 16 as a work area.

The display unit 11 displays various screens and images. The display unit 11 may be, for example, a liquid crystal display. The operation unit 12 receives an input operation by a user. For example, the operation unit 12 includes a keyboard, a mouse, a touch panel, and a handwriting input pad.

The communication interface 13 is an interface for connecting the information processing apparatus 1 to the network 4. The information processing apparatus 1 communicates with the image processing apparatus 2 via the communication interface 13.

The storage unit 14 is a non-volatile storage device including a hard disk drive (HDD) or a solid-state drive (SSD). The storage unit 14 stores a program 17 to be executed by the CPU 15 and various image data 18. For example, the image data 18 includes various photographs, illustrations, graphs, tables, line drawings, plain images (single-color images), color images, and the like.

Returning to FIG. 1, the image processing apparatus 2 includes a scanner 3 that optically reads an image of a document such as a paper document set by a user to generate image data. That is, the scanner 3 is an image reading device.

The image processing apparatus 2 has a character recognition function based on AI. Therefore, the image processing apparatus 2 is capable of recognizing a character string included in image data generated by the scanner 3 and converting the recognized character string into text data. That is, the image processing apparatus 2 functions as a character recognition apparatus that performs character recognition processing using AI. The image processing apparatus 2 can improve the character recognition accuracy by AI by performing machine learning of various learning images including character strings in advance.

The information processing apparatus 1 functions as a learning image generation apparatus 5. Therefore, the information processing apparatus 1 generates a large number of learning images required for improving the character recognition accuracy in the image processing apparatus 2. Then, the information processing apparatus 1 provides a large number of learning images to the image processing apparatus 2. Hereinafter, the information processing apparatus 1 will be described as a learning image generation apparatus 5.

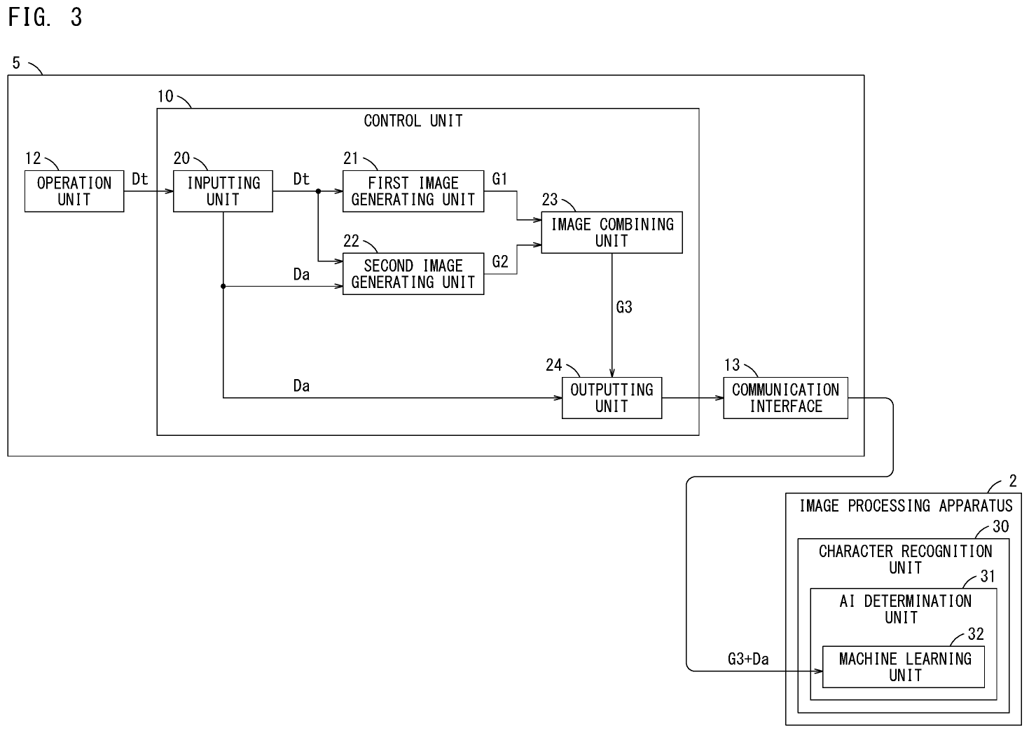

FIG. 3 is a block diagram illustrating a functional configuration of each of the learning image generation apparatus 5 and the image processing apparatus 2.

The image processing apparatus 2 includes a character recognition unit 30 that performs a character recognition process using AI. The character recognition unit 30 includes an AI determination unit 31 that determines whether or not an image component included in input image data is a character string by AI. Further, the AI determination unit 31 includes a machine learning unit 32. The machine learning unit 32 constructs a neural network model for recognizing a character string by performing machine learning such as deep learning using the learning image provided from the learning image generation apparatus 5.

The control unit 10 of the learning image generation apparatus 5 functions as an inputting unit 20, a first image generating unit 21, a second image generating unit 22, an image combining unit 23, and an outputting unit 24 when the CPU15 executes the program 17. The control unit 10 causes these units to function to generate a large number of learning images for causing the machine learning unit 32 of the image processing apparatus 2 to perform machine learning. For example, when one character string is input by the user, the learning image generation apparatus 5 generates a plurality of learning images including the one character string and provides the learning images to the image processing apparatus 2. Therefore, the user can input a large number of learning images to the image processing apparatus 2 at a time by using the learning image generation apparatus 5 and can cause the machine learning unit 32 to efficiently perform machine learning.

The inputting unit 20 accepts an input of a character string Dt from the operation unit 12. That is, the inputting unit 20 specifies the character string Dt input by the user based on the user's operation on the operation unit 12, and receives the specified character string Dt. For example, when the user inputs a character string Dt through the keyboard, the inputting unit 20 receives the character string Dt input by the user as text data. By receiving the character string Dt as text data, the character string Dt input to the inputting unit 20 becomes a known character string.

Furthermore, when the user enters a character string Dt by handwriting on the handwriting input pad, the inputting unit 20 accepts the character string Dt as image data. In this case, it is unclear what kind of character string is included in the image data. Therefore, the character string Dt accepted by the inputting unit 20 is not known. When the character string Dt is input by handwriting on the handwriting input pad, the inputting unit 20 further receives input of text data corresponding to the character string Dt input by handwriting by the user via a keyboard or the like, and acquires the text data corresponding to the handwritten character string Dt. With this text data, the character string Dt input by handwriting becomes a known character string.

In a case where the input of the known character string Dt is received, the inputting unit 20 outputs the character string Dt to the first image generating unit 21 and the second image generating unit 22. For example, in a case where the inputting unit 20 receives the character string Dt input by the user as text data, the inputting unit 20 outputs the text data as the character string Dt to each of the first image generating unit 21 and the second image generating unit 22. In a case where the inputting unit 20 receives the character string Dt input by the user as image data, the inputting unit 20 outputs the image data to the first image generating unit 21 as the character string Dt.

In addition, the inputting unit 20 sets text data corresponding to the known character string Dt as correct answer data Da, and outputs the correct answer data Da to the first image generating unit 21, the second image generating unit 22, and the outputting unit 24. For example, when the inputting unit 20 receives a character string Dt input by the user as text data, the correct answer data Da is the same data as the character string Dt. In this case, the inputting unit 20 outputs the correct answer data Da to the outputting unit 24. In contrast, when a character string Dt input by the user is accepted as image data, the correct answer data Da is text data different from the character string Dt. In this case, the inputting unit 20 outputs the correct answer data Da represented by text data to each of the second image generating unit 22 and the outputting unit 24.

The first image generating unit 21 acquires the character string Dt output from the inputting unit 20 and generates the first image G1 including the character string Dt. For example, the first image generating unit 21 generates the first image G1 including the character string Dt by converting the character string Dt into image data. When the character string Dt is text data, the first image generating unit 21 converts the text data into image data in a format such as JPEG or bitmap to generate the first image G1. Furthermore, in a case of image data in which the character string Dt is input by handwriting, the first image generating unit 21 converts the image data into image data such as JPEG or bitmap to generate the first image G1.

When generating the first image G1, the first image generating unit 21 generates a processing parameter for processing the character string Dt. The first image generating unit 21 processes the character string Dt based on the processing parameter. The first image generating unit 21 generates the first image G1 including the processed character string Dt. For example, when the character string Dt is text data, the processing parameters include a font, a size, a thickness, a color, a density, an arrangement direction, and an inclination angle. In a case where the character string Dt is image data, the processing parameters include, for example, an enlargement rate, a reduction rate, an image rotation angle, and an inclination angle. The first image generating unit 21 processes the character string Dt based on those processing parameters and generates the first image G1 including the processed character string Dt.

In addition, the first image generating unit 21 generates a plurality of processing parameters and processes the character string Dt based on each of the plurality of processing parameters to generate a plurality of character strings having different forms. Accordingly, the first image generating unit 21 can generate a plurality of first images G1 including the character strings Dt of different forms. That is, the first image generating unit 21 generates M (M is a positive integer equal to or greater than 2) first images G1 by performing different processes on one character string Dt. Then, the first image generating unit 21 outputs the plurality of first images G1 including the character strings Dt of different forms to the image combining unit 23.

The second image generating unit 22 generates a second image G2 to be combined with the first image G1. The second image generating unit 22 generates the second image G2 including, as image components, disturbance elements different from the character string Dt to be recognized when the machine learning unit 32 performs machine learning. The second image generating unit 22 can generate a plurality of second images G2.

For example, the second image generating unit 22 generates a seal impression image (a stamp image including the character string) obtained by processing the character string Dt based on text data of the character string Dt and generates the second image G2 including the seal impression image. Specifically, the second image generating unit 22 generates the seal impression image by converting the font of the characters included in the text data into a seal style font and arranging a character string of the seal style font inside a circular frame or a square frame. The second image generating unit 22 generates a second image G2 including the seal impression image.

The second image generating unit 22 can also generate the second image G2 including a ruled line or a frame line to be combined with the character string included in the first image G1 or to be combined with the periphery of the character string included in the first image G1. The second image generating unit 22 can also generate the second image G2 including noise components. The second image generating unit 22 can also read the image data 18 stored in the storage unit 14 and generate the second image G2 including an arbitrary image such as a color image or a plain image based on the image data 18. The second image generating unit 22 can also generate the second image G2 including a character string different from the character string Dt. Further, the second image generating unit 22 can generate the second image G2 including an image in which a character string different from the character string Dt is horizontally inverted. The second image generating unit 22 performs these processes to generate the second image G2 including various disturbance elements as image components.

When the second image generating unit 22 generates the second image G2 as described above, the second image generating unit 22 outputs the second image G2 to the image combining unit 23.

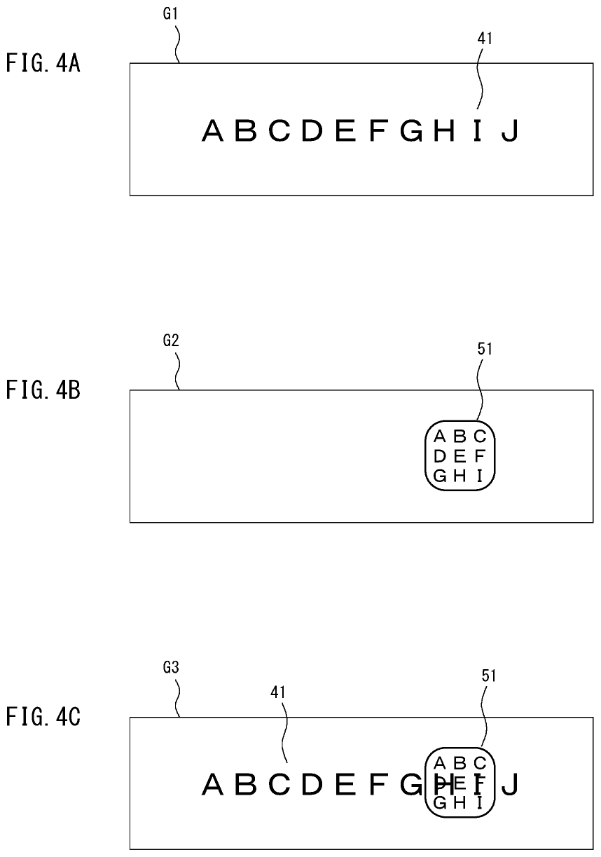

The image combining unit 23 generates the learning image G3 by combining the first image G1 and the second image G2. FIGS. 4A to 4C are diagrams illustrating the concept of the processing by the image combining unit 23. FIG. 4A shows an example of the first image G1. The first image G1 includes a character string 41 of “ABCDEFGHIJ”. This character string 41 is a character string obtained by processing the above-described character string Dt. FIG. 4B shows an example of the second image G2. This second image G2 includes the seal impression image 51. The image combining unit 23 combines the first image G1 illustrated in FIG. 4A and the second image G2 illustrated in FIG. 4B to generate a learning image G3 as illustrated in FIG. 4C. At this time, the image combining unit 23 generates the learning image G3 in which the seal impression image 51 included in the second image G2 is superimposed and combined on the character string 41 of the first image G1. As a result, the seal impression image 51 becomes a noise component when the character string 41 is recognized.

In a case where the second image G2 is combined with the first image G1, the image combining unit 23 can generate the plurality of learning images G3 by changing combining parameters such as the transmittance of each of the first image G1 and the second image G2, the combining position of the second image G2 with respect to the first image G1, the arrangement angle of the second image G2 with respect to the first image G1, and the distortion with respect to at least one of the first image G1 and the second image G2. Note that the distortion is to distort a rectangular image into a parallelogram image at the time of image combining.

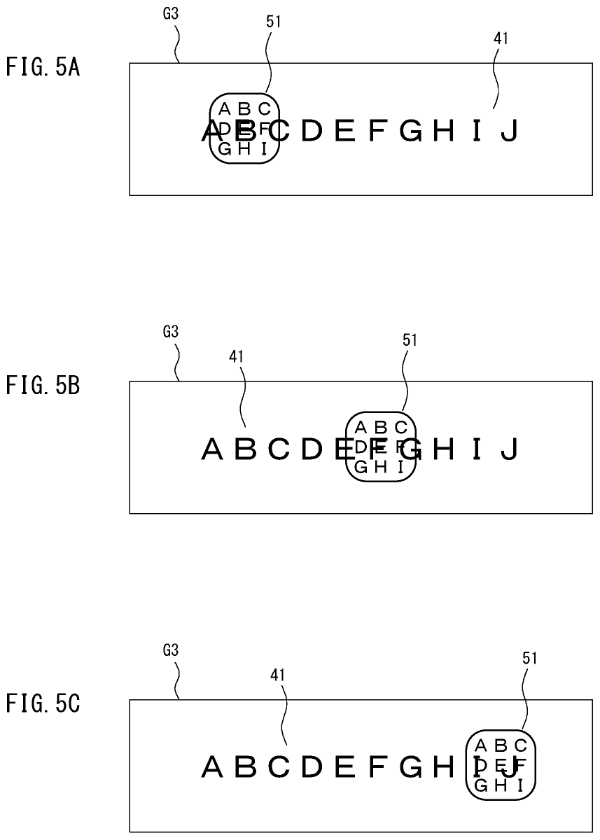

FIG. 5A to FIG. 5C are diagrams illustrating a case where the combining position of the second image G2 with respect to the first image G1 is changed. FIG. 5A shows an example in which the seal impression image 51 included in the second image G2 is combined with the head portion of the character string 41 included in the first image G1. FIG. 5B shows an example in which the seal impression image 51 included in the second image G2 is combined with a central portion of the character string 41 included in the first image G1. Further, FIG. 5C shows an example in which the seal impression image 51 included in the second image G2 is combined with the tail portion of the character string 41 included in the first image G1. As described above, the image combining unit 23 can change the portion of the character string 41 that reduces the legibility by changing the combining position of the seal impression image 51 with respect to the character string 41. As a result, the image combining unit 23 generates various learning images G3. Although the case where the seal impression image 51 is included in the second image G2 is illustrated in FIGS. 5A to 5C, an image different from the seal impression image 51 may be included in the second image G2.

In a case where the M first images G1 including the character string 41 of the different form are generated by the first image generating unit 21, the image combining unit 23 combines the second image G2 with each of the plurality of first images G1 to generate at least M learning images G3.

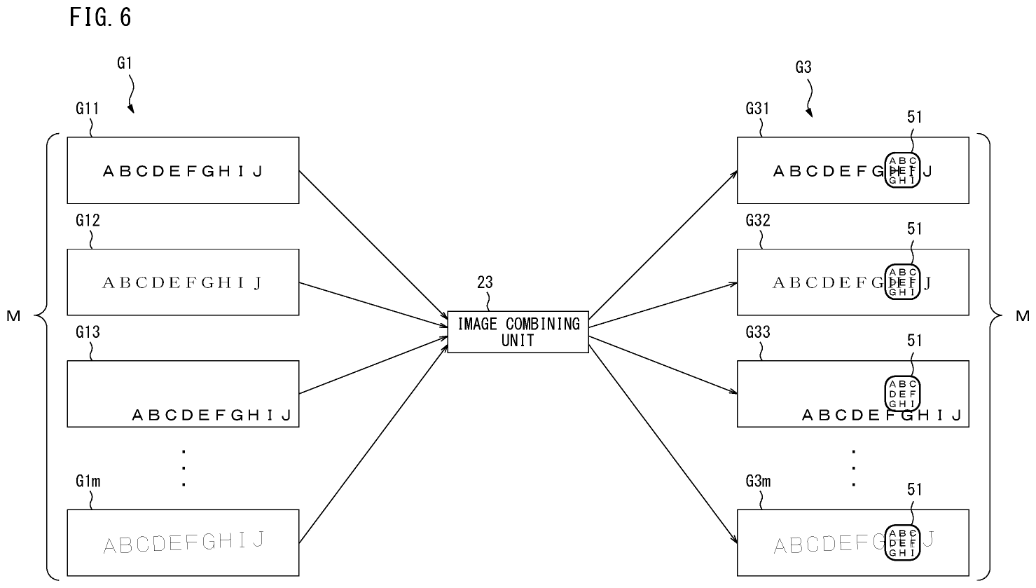

FIG. 6 is a diagram illustrating an example of generating M learning images G3 from M first images G1. For example, as shown in FIG. 6, in a case where M first images G1 including character strings 41 of different forms are generated by the first image generating unit 21, the image combining unit 23 combines the second images G2 with the M first images G1 to generate M learning images G3. In this case, M learning images G3 are generated from one character string input to the inputting unit 20. In addition, by changing the combining parameter when the second image G2 is combined with the first image G1, the image combining unit 23 can generate a plurality of learning images G3 from one first image G1. That is, the image combining unit 23 can generate M or more learning images G3 from the M first images G1. Therefore, the image combining unit 23 can generate a large number of learning images G3 at a time for causing the machine learning unit 32 to perform machine learning.

In a case where the plurality of second images G2 are generated by the second image generating unit 22, the image combining unit 23 combines the plurality of second images G2 one by one with each of the plurality of first images G1 to generate more learning images G3. Accordingly, the image combining unit 23 can generate a large number of learning images G3 at once from one character string input by the user.

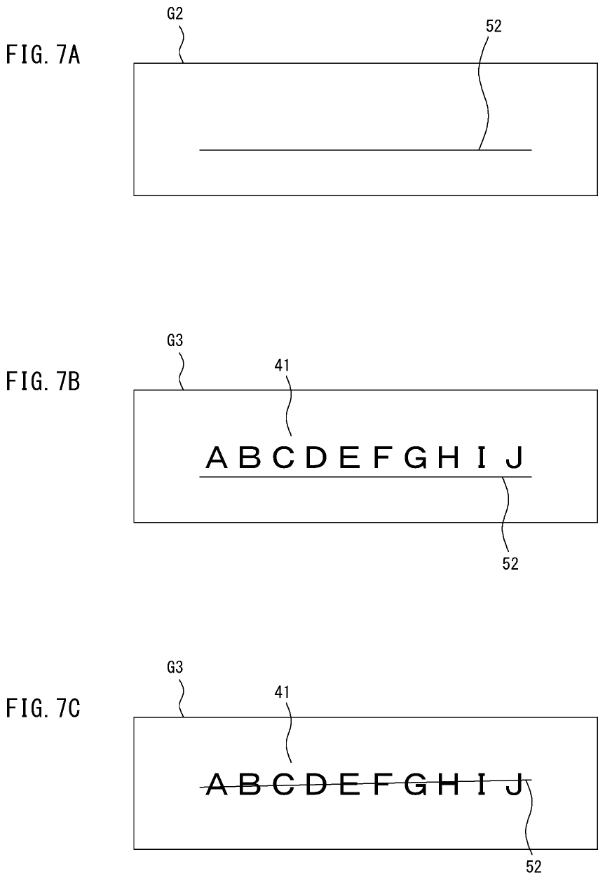

Next, a case where the second image G2 including the ruled line is generated by the second image generating unit 22 will be described. FIG. 7A shows the second image G2 generated by the second image generating unit 22. The second image G2 includes a ruled line 52 to be added to a lower portion of the character string 41 included in the first image G1. When generating the second image G2, the second image generating unit 22 specifies a region (position) including the character string 41 in the first image G1 and generates the second image G2 in which the ruled line 52 is added to a position corresponding to the lower portion of the character string 41.

When the second image G2 as illustrated in FIG. 7A is generated, the image combining unit 23 combines the second image G2 with the first image G1 to generate a learning image G3 as illustrated in FIG. 7B. Accordingly, the learning image generation apparatus 5 can generate the learning image G3 in which the ruled line 52 such as an underline is added to the character string 41.

Further, when combining the second image G2 illustrated in FIG. 7A with the first image G1, the image combining unit 23 changes the combining position or the arrangement angle of the second image G2. Thus, as illustrated in FIG. 7C, the image combining unit 23 can also generate a learning image G3 in which a ruled line 52 overlaps a character string 41.

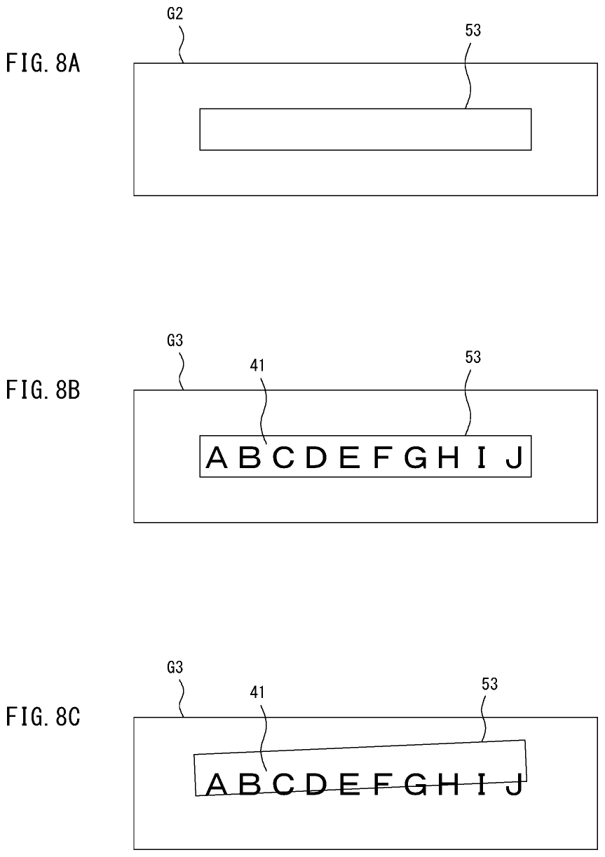

Next, a case where the second image G2 including the frame line is generated by the second image generating unit 22 will be described. FIG. 8A shows the second image G2 generated by the second image generating unit 22. The second image G2 includes one frame line 53 surrounding the entire character string 41 included in the first image G1. When generating the second image G2, the second image generating unit 22 specifies a region (position) including the character string 41 in the first image G1 and generates the second image G2 in which the frame line 53 is added to a peripheral position surrounding the entire character string 41.

When the second image G2 as illustrated in FIG. 8A is generated, the image combining unit 23 combines the second image G2 with the first image G1 to generate a learning image G3 as illustrated in FIG. 8B. As a result, the learning image generation apparatus 5 can generate the learning image G3 with the frame line 53 surrounding the entire character string 41.

Further, when combining the second image G2 illustrated in FIG. 8A with the first image G1, the image combining unit 23 changes the combining position or the arrangement angle of the second image G2. Thus, as illustrated in FIG. 8C, the image combining unit 23 can also generate a learning image G3 in which a part of the frame line 53 overlaps the character string 41.

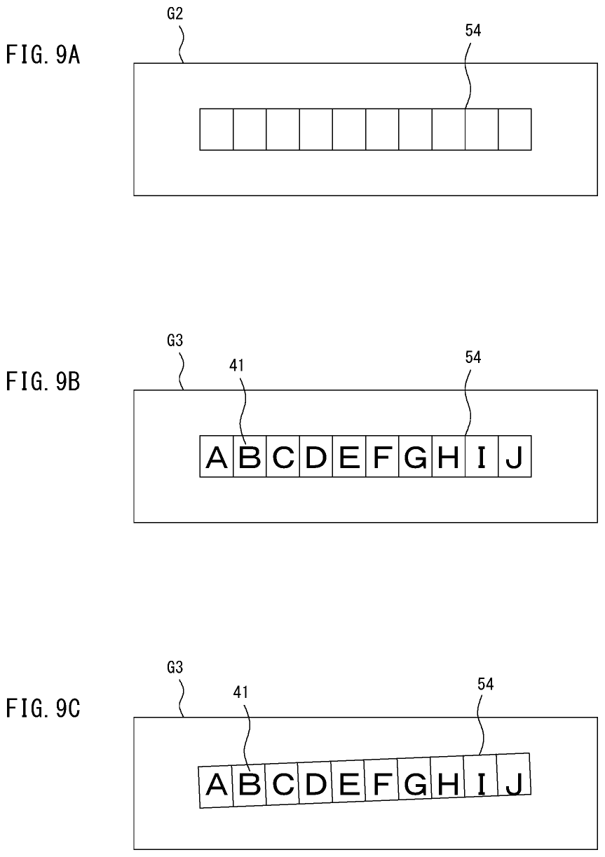

Next, a case where the second image G2 including a frame line different from the one of FIG. 8A is generated by the second image generating unit 22 will be described. FIG. 9A shows the second image G2 generated by the second image generating unit 22. The second image G2 includes a frame line 54 that encloses each character of the character string 41 included in the first image G1 one by one. When generating the second image G2, the second image generating unit 22 specifies a region (position) including the character string 41 in the first image G1 and generates the second image G2 in which the frame line 54 is added to a position where each character of the character string 41 is inserted one by one.

When the second image G2 as illustrated in FIG. 9A is generated, the image combining unit 23 combines the second image G2 with the first image G1 to generate a learning image G3 as illustrated in FIG. 9B. As a result, the learning image generation apparatus 5 can generate the learning image G3 to which the frame line 54 enclosing each character of the character string 41 one by one is added.

Further, when combining the second image G2 illustrated in FIG. 9A with the first image G1, the image combining unit 23 changes the combining position or the arrangement angle of the second image G2. Thus, as illustrated in FIG. 9C, the image combining unit 23 can generate the learning image G3 in a state where each character of the character string 41 is inclined with respect to each frame line, or in a state where the frame line 54 overlaps at least a part of the characters.

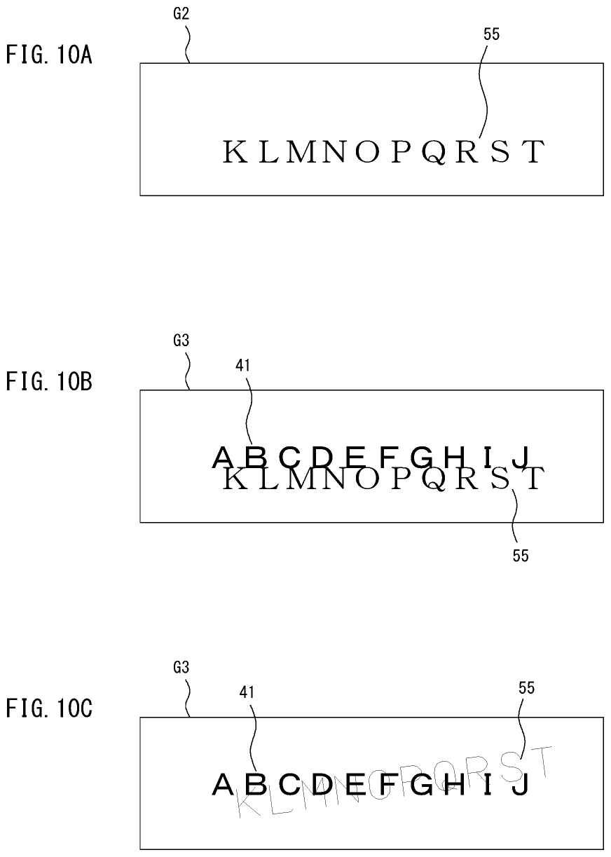

Next, a case where the second image G2 including a character string different from the character string 41 is generated by the second image generating unit 22 will be described. FIG. 10A shows the second image G2 generated by the second image generating unit 22. The second image G2 includes a character string 55 different from the character string 41 included in the first image G1. In a case where the second image G2 is generated, the second image generating unit 22 generates an arbitrary character string 55 different from the character string 41 on the basis of the text data of the character string 41 and generates the second image G2 to which the character string 55 is added.

However, when the character string 55 is included in the second image G2, there is a possibility that the character string 55 becomes a recognition target of the character recognition processing. In order to prevent this, it is preferable that the second image generating unit 22 horizontally inverts the character string 55 when generating the character string 55. At this time, the second image generating unit 22 may horizontally invert each character included in the character string 55 one by one, instead of horizontally inverting the entire character string 55. Thus, the character string 55 can be generated as an image of a character string in a show-through mode and can be prevented from being erroneously recognized as a character string to be recognized in the character recognition processing. A case where the horizontally inversion of the character string 55 is not performed in FIGS. 10A, 10B, and 10C is illustrated.

In a case where the second image G2 including the character string 55 is generated, the image combining unit 23 combines the second image G2 with the first image G1 to generate the learning image G3 as illustrated in FIG. 10B. Thus, the learning image generation apparatus 5 can generate the learning image G3 in which the character string 55 different from the character string 41 is added to the character string 41.

In a case where the image combining unit 23 combines the second image G2 such as FIG. 10A to the first image G1, by changing the combining position or the arrangement angle of the second image G2, it is possible to generate the learning image G3 in which each character of the character string 55 is inclined with respect to the character string 41 as shown in FIG. 10C or the character string 55 is superimposed on at least a part of the character string 41. In addition, when the image combining unit 23 combines the second image G2 with the first image G1, for example, by setting the transmissivity of the second image G2 to a value smaller than the transmissivity of the first image G1, it is possible to display the character string 55 in the show-through mode in a thin manner.

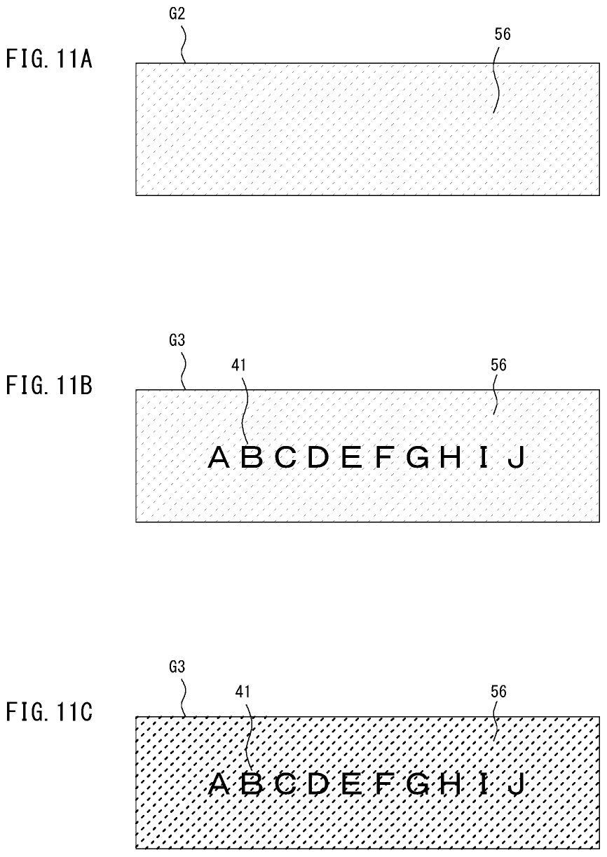

Next, a case where the second image G2 including an image based on the image data 18 is generated by the second image generating unit 22 will be described. FIG. 11A to FIG. 11C illustrate a plain image as an image based on the image data 18. FIG. 11A shows the second image G2 generated by the second image generating unit 22. The second image G2 of FIG. 11A includes a plain image 56 based on the image data 18. The plain image 56 is an image whose color and density are constant in the image plane. The second image generating unit 22 reads out the image data 18 of the plain image 56 from the plurality of image data 18 stored in the storage unit 14 and generates the second image G2 on the basis of the image data 18. At this time, the second image generating unit 22 may generate the plurality of second images G2 by changing the color or density of the plain image 56 to another color or density.

When the second image G2 including the plain image 56 is generated, the image combining unit 23 combines the second image G2 with the first image G1 to generate the learning image G3 as shown in FIG. 11B. As a result, the learning image generation apparatus 5 can generate the learning image G3 in which the character string 41 is combined with the region having the plain image 56 as the background.

In addition, when combining the second image G2 such as FIG. 11A with the first image G1, the image combining unit 23 changes the color or density of the second image G2. Thus, as illustrated in FIG. 11C, the image combining unit 23 is also capable of generating a learning image G3 in which the color or density of the background portion formed by the plain image 56 is different. Although the plain image 56 is illustrated in FIG. 11A to FIG. 11C, the image included in the second image G2 is not limited to the plain image 56 and may be a photograph, an illustration, a graph, a table, a line drawing, or other color images.

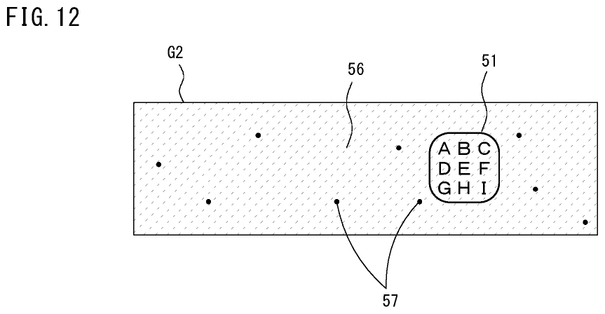

Further, the second image generating unit 22 may generate the second image G2 including two or more image components among the images based on the image data 18 such as the seal impression image 51, the ruled line 52, the frame lines 53 and 54, the character string 55, and the plain image 56 described above. FIG. 12 shows an example of the second image G2 including the seal impression image 51 and the plain image 56. The second image generating unit 22 can also generate the second image G2 including a plurality of image components as shown in FIG. 12. Further, as illustrated in FIG. 12, the second image generating unit 22 may randomly dispose a stain image 57 simulating a stain of a document on the second image G2. Thus, since the learning image G3 in which the stain image 57 overlaps the character string 41 can be generated, the machine learning unit 32 can recognize the character string 41 even when the document is in a stained state by learning the learning image G3.

After generating the learning image G3 by combining the first image G1 and the second image G2, the image combining unit 23 outputs the learning image G3 to the outputting unit 24. As described above, the image combining unit 23 generates a plurality of learning images G3 from one character string Dt. Therefore, the image combining unit 23 outputs the plurality of learning images G3 generated from the character string Dt to the outputting unit 24.

When acquiring the plurality of learning images G3 from the image combining unit 23, the outputting unit 24 outputs the plurality of learning images G3 to the machine learning unit 32 via the communication interface 13. The outputting unit 24 outputs the correct answer data Da of the character string Dt to the machine learning unit 32 together with the learning image G3. As a result, the machine learning unit 32 recognizes that the character string 41 included in the plurality of learning images G3 output from the learning image generation apparatus 5 is a character string indicated by the correct answer data Da. Therefore, the machine learning unit 32 performs machine learning to construct a neural network model so that the character string indicated by the correct answer data Da can be recognized from each of the plurality of learning images G3. It is possible to improve the character recognition accuracy in a case where the character recognition processing is actually performed on the image data generated by the scanner 3.

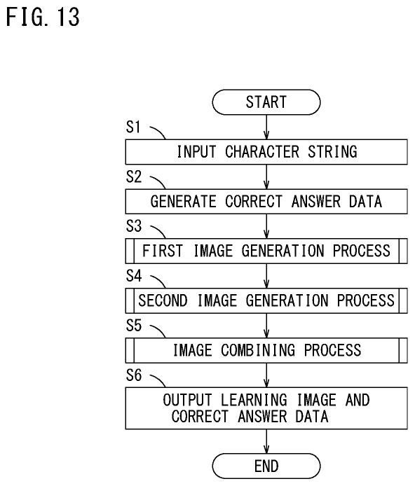

Next, an example of a processing procedure performed in the learning image generation apparatus 5 will be described. FIG. 13 to FIG. 16 are flowcharts illustrating an example of a processing procedure performed in the learning image generation apparatus 5. This processing is performed by the CPU 15 of the control unit 10 executing the program 17 in the learning image generation apparatus 5.

As illustrated in FIG. 13, when the learning image generation apparatus 5 starts this processing, the control unit 10 causes the inputting unit 20 to function. The inputting unit 20 inputs a character string Dt (step S1). That is, the learning image generation apparatus 5 inputs the character string Dt based on the user's operation on the operation unit 12. For example, the learning image generation apparatus 5 inputs the character string Dt as text data or image data.

The learning image generation apparatus 5 generates the correct answer data Da corresponding to the input character string Dt (step S2). When the character string Dt is input as text data, the correct answer data Da is the same data as the text data. In addition, in a case where the character string Dt is image data input by handwriting, the inputting unit 20 generates the correct answer data Da which is text data on the basis of a user operation performed on a keyboard or the like.

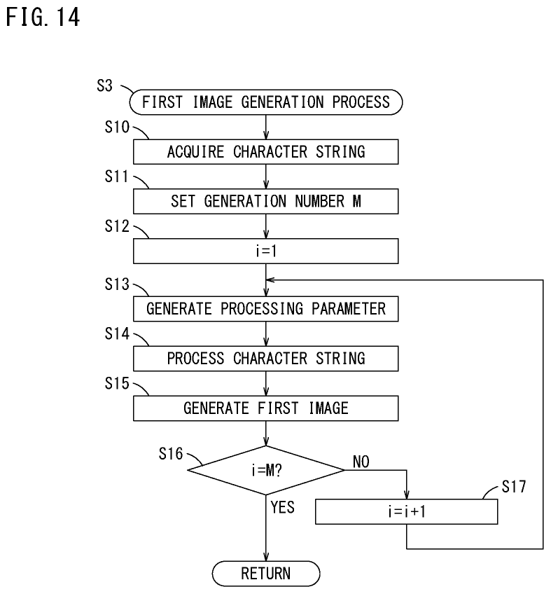

Next, the learning image generation apparatus 5 causes the first image generating unit 21 to function to execute first image generation processing (step S3). FIG. 14 is a flowchart illustrating an example of a detailed processing procedure of the first image generation processing (step S3). In a case where the first image generation process is started, the learning image generation apparatus 5 acquires the character string Dt (step S10) and sets the generation number M (M is a natural number equal to or greater than 2) of the first images G1 (step S11). The generation number M may be set in advance by the user, for example. Then, the learning image generation apparatus 5 initializes the variable “i” to 1 (step S12).

Subsequently, the learning image generation apparatus 5 generates a processing parameter for processing the character string Dt (step S13) and processes the character string Dt based on the processing parameter (step S14). Thus, the display mode of the character string Dt changes in accordance with the processing parameter, and the character string 41 included in the first image G1 is generated. The learning image generation apparatus 5 generates the first image G1 by converting the image including the character string 41 obtained by processing the character string Dt into a predetermined image data (step S15).

Next, the learning image generation apparatus 5 determines whether or not the variable i is equal to the generation number M (step S16). When the variable i is less than the generation number M (NO in step S16), the learning image generation apparatus 5 adds 1 to the variable i (step S17) and repeats the processing of steps S13 to S15. At this time, the processing parameter generated in step S13 is different from the previously generated processing parameters. As a result, the first image G1 including the character string 41 obtained by processing the character string Dt into a form different from the previous form is repeatedly generated. By repeating the processing of steps S13 to S15 M times, the learning image generation apparatus 5 can generate M first images G1 including the character string 41 on which different processing has been performed. Thereafter, in a case where it is determined in Step S16 that the variable i is equal to the generation number M (YES in Step S16), the first image generation process ends, and the process returns to the flowchart of FIG. 13.

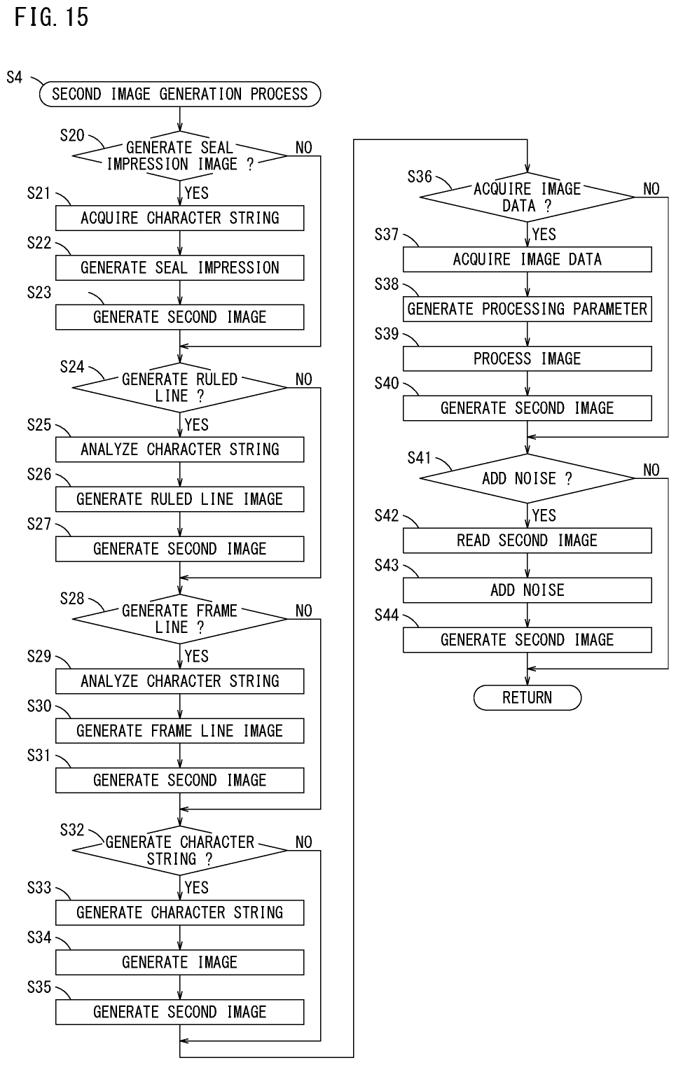

Next, the learning image generation apparatus 5 brings the second image generating unit 22 into operation to execute a second image generation process (step S4). FIG. 15 is a flowchart illustrating an example of a detailed processing procedure of the second image generation processing (step S3). When starting the second image generation processing, the learning image generation apparatus 5 determines whether to generate the seal impression image 51 (step S20). For example, whether to generate the seal impression image 51 is preset by the user. Upon determination to generate the seal impression image 51 (YES in step S20), the learning image generation apparatus 5 acquires the character string Dt (step S21) and processes the character string Dt to generate the seal impression image 51 (step S22). In a case where the character string Dt is the image data by the handwritten input, the correct answer data Da is acquired instead of the character string Dt, and the seal impression image 51 is generated based on the correct answer data Da. Then, the learning image generation apparatus 5 generates the second image G2 including the generated seal impression image 51 (step S23). At this time, the learning image generation apparatus 5 may generate the plurality of second images G2 by changing positions where the seal impression images 51 are included in the second images G2. When determining not to generate the seal impression image 51 (NO in step S20), the learning image generation apparatus 5 skips the processes of steps S21 to S23.

Subsequently, the learning image generation apparatus 5 determines whether to generate a second image G2 with ruled lines 52 (step S24). For example, whether to generate the second image G2 with the ruled line 52 is set in advance by the user. In a case where the learning image generation apparatus 5 determines to generate the second image G2 with the ruled line 52 (YES in step S24), the learning image generation apparatus 5 analyzes a region including the character string 41 in the first image G1 (step S25) and generates an image representing the ruled line 52 (step S26). Then, the learning image generation apparatus 5 generates the second image G2 including the generated ruled line 52 (step S27). At this time, the learning image generation apparatus 5 may generate the plurality of second images G2 by changing the position or the arrangement angle at which the ruled line 52 is included in the second image G2. When determining not to generate the second image G2 with the ruled line 52 (NO in step S24), the learning image generation apparatus 5 skips the processing in steps S25 to S27.

Subsequently, the learning image generation apparatus 5 determines whether to generate the second images G2 with the frame line 53 or 54 (step S28). For example, whether to generate the second image G2 with the frame line 53 or 54 is preset by the user. When the learning image generation apparatus 5 determines to generate the second image G2 with the frame line 53 or 54 (YES in step S28), the learning image generation apparatus 5 analyzes a region including the character string 41 in the first image G1 (step S29) and generates an image representing the frame line 53 or the frame line 54 (step S30). Then, the learning image generation apparatus 5 generates the second image G2 including the generated frame line 53 or 54 (step S31). At this time, the learning image generation apparatus 5 may generate a plurality of second images G2 by changing positions or arrangement angles at which the frame line 53 or 54 are included in the second image G2. When the learning image generation apparatus 5 determines not to generate the second image G2 with the frame line 53 or 54 (NO in step S28), it skips the processing of steps S29 to S31.

Subsequently, the learning image generation apparatus 5 determines whether to generate a second image G2 with a character string 55 different from the character string Dt (step S32). For example, whether to generate the second image G2 to which the character string 55 is set in advance by the user. When determining to generate the second image G2 to which the character string 55 is added (YES in step S32), the learning image generation apparatus 5 generates the character string 55 different from the character string Dt (step S33) and generates an image including the character string 55 (step S34). At this time, it is preferable that the learning image generation apparatus 5 generates an image in which the entire character string 55 is horizontally reversed. Alternatively, an image in which individual characters included in the character string 55 are horizontally reversed may be generated. Then, the learning image generation apparatus 5 generates the second image G2 including the image of the character string 55 (step S35). At this time, the learning image generation apparatus 5 may generate a plurality of second images G2 by changing a position or an arrangement angle at which the image of the character string 55 is included in the second image G2. When determining not to generate the second image G2 to which the character string 55 is attached (NO in step S32), the learning image generation apparatus 5 skips the processes of steps S33 to S35.

Subsequently, the learning image generation apparatus 5 determines whether to generate the second image G2 by acquiring the image date 18 (step S36). For example, whether to acquire the image 18 and generate the second image G2 is set in advance by the user. When the learning image generation apparatus 5 determines to acquire the image datum 18 and generate the second image G2 (YES in step S36), the learning image generation apparatus 5 reads and acquires the image data 18 from the storage unit 14 (step S38). At this time, the learning image generation apparatus 5 acquires the image data 18 designated by the user. The number of pieces of image data 18 read and acquired from the storage unit 14 is not limited to one and may be plural. Upon acquiring the image data 18, the learning image generation apparatus 5 generates processing parameters for processing and adjusting color or density (step S38), and processes an image based on the image data 18 on the basis of the processing parameters (step S39). Then, the learning image generation apparatus 5 generates the second image G2 including the processed image (step S40). Thus, the second image G2 including, for example, the above-described plain image 56 is generated. However, the image included in the second image G2 is not limited to the plain image 56. Further, the learning image generation apparatus 5 may generate a plurality of processing parameters for processing the image data 18 and may generate a plurality of second images G2 by processing the image based on the image data 18 based on each of the plurality of processing parameters. When the learning image generation apparatus 5 determines not to generate the second image G2 including the image data 18 (NO in step S36), it skips the processing of steps S37 to S40.

Subsequently, the learning image generation apparatus 5 determines whether to add noise components such as the stain image 57 to the second image G2 (step S41). For example, whether to add the noise components to the second image G2 is preset by a user. When the learning image generation apparatus 5 determines to add noise components such as the stain image 57 to the second image G2 (YES in step S41), the learning image generation apparatus 5 reads the second image G2 generated (step S42), adds noise components to the second image G2 (step S43), and generates a new second image G2 (step S44). When determining not to add noise components to the second image G2 (NO in step S41), the learning image generation apparatus 5 skips the processing of steps S42 to S44. Then, the second image generation process ends, and the process returns to the flowchart of FIG. 13.

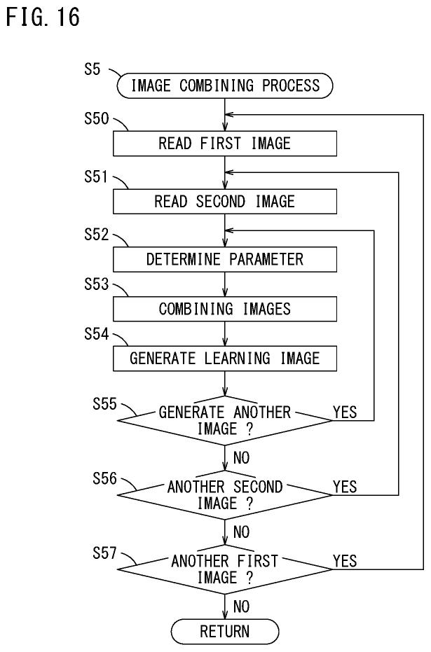

Next, the learning image generation apparatus 5 causes the image combining unit 23 to function and executes image combining process (step S5). FIG. 16 is a flowchart illustrating an example of a detailed processing procedure of the image combining process (step S5). When starting the image combining process, the learning image generation apparatus 5 reads the first image G1 (step S50). In addition, the learning image generation apparatus 5 reads the second image G2 (step S51). The learning image generation apparatus 5 determines a combining parameter when the second image G2 is combined with the first image G1 (step S52). Accordingly, the transparency of each of the first image G1 and the second image G2, the combining position of the second image G2 with respect to the first image G1, the arrangement angle of the second image G2 with respect to the first image G1, the distortion of each of the first image G1 and the second image G2, and the like are determined. The learning image generation apparatus 5 combines the second image G1 with the first image G2 by applying the combining parameter determined in step S52 (step S53) and generates the learning image G3 (step S54).

Subsequently, the learning image generation apparatus 5 determines whether to generate another learning image G3 without changing the first image G1 and the second image G2 (step S55). When another learning image G3 is to be generated (YES in step S55), the learning image generation apparatus 5 repeats the processing of steps S52 to S54. At this time, the combining parameter generated in step S52 is a parameter different from the combining parameter generated before. Accordingly, it is possible to further generate the learning image G3 different from the previous time without changing the first image G1 and the second image G2. For example, if a plurality of variations is prepared in advance as the combining parameter, the learning image G3 to which each of the plurality of variations is applied can be automatically generated.

When another learning image G3 is not generated (NO in step S55), the learning image generation apparatus 5 determines whether another second image G2 is generated (step S56). In a case where another second image G2 is generated (YES in step S56), the learning image generation apparatus 5 repeats the processing of steps S51 to S55. Thus, processing is performed in which another second image G2 is combined with the first image G1 read in step S50 to generate a learning image G3.

On the other hand, upon determination that another second image G2 does not exist (NO in step S56), the learning image generation apparatus 5 determines whether another first image G1 has been generated (step S57). In a case where another first image G1 is generated (YES in step S57), the learning image generation apparatus 5 repeats the processing of steps S50 to S56. Accordingly, another first image G1 is read out, and a process of generating the learning image G3 by combining the second image G2 with the first image G1 is performed. Then, the process of steps S51 to S56 is performed for all the first images G1, and in a case where it is determined that another first image G1 does not exist (NO in step S57), the image combining process ends.

Returning to the flowchart of FIG. 13, next, the learning image generation apparatus 5 causes the outputting unit 24 to function, and outputs the learning image G3 and the correct answer data Da generated in the above processing as one data set to the machine learning unit 32 (step S6). The learning image generation apparatus 5 is not limited to directly outputting the data set including the learning image G3 and the correct answer data Da to the machine learning unit 32 of the image processing device 2 and may output and store the data set in a storage device such as a universal serial bus (USB) memory. This completes the processing performed by the learning image generation apparatus 5.

As described above, the learning image generation apparatus 5 of the present embodiment comprises the first image generating unit 21 that receives the character string Dt and generates the first image G1 including the character string Dt, the second image generating unit 22 that generates the second image G2 to be combined with the first image G1, the image combining unit 23 that generates the learning image G3 by combining the first image G1 and the second image G2, and the outputting unit 24 that outputs the learning image G3 and the correct answer data Da of the character string Dt. Therefore, the learning image generation apparatus 5 can automatically generate the learning image G3 for causing the machine learning unit 32 to perform machine learning for character recognition only by inputting the character string Dt. In particular, since the user can easily create the learning image G3 by simply inputting the character string Dt to the learning image generation apparatus 5, there is an advantage that a large number of learning images G3 can be easily prepared.

In addition, the learning image generation apparatus 5 of the present embodiment can generate a plurality of first images G1 by performing various processes on one character string Dt and generate a plurality of learning images G3 by combining the second image G2 with the plurality of first images G1. For example, image data generated by the scanner 3 includes character strings in various forms in terms of font, size, thickness, color, density, arrangement direction, and inclination angle. Furthermore, if noise is mixed when the scanner 3 reads a document, the definition of a character string may decrease. Therefore, the learning image generation apparatus 5 generates the character strings 41 of various forms from one character string Dt and generates the plurality of learning images G3 including the character strings 41, whereby in a case where the machine learning unit 32 performs machine learning using the learning image G3, it is possible to learn the character strings of various forms in terms of a font, a size, a thickness, a color, a density, an arrangement direction, and an inclination angle, and to discriminate noise mixed in a case where the scanner 3 reads a document. Accordingly, in a case where the learning image G3 generated by the learning image generation apparatus 5 is used, the robustness of AI can be secured, and the character recognition accuracy by AI can be improved.

In addition, the learning image generation apparatus 5 of the present embodiment can generate not only the first image G1 but also a plurality of second images G2 when generating the second image G2. For example, in a case where M first images G1 are generated and N second images G2 are generated (here, N is a natural number of 2 or more), the learning image generation apparatus 5 can generate M×N learning images G3 from one character string Dt. At this time, since the user only inputs one character string Dt, there is an advantage that a large number of learning images G3 can be acquired at a time by a simple operation.

The preferred embodiments of the present invention have been described above. However, the present invention is not limited to the content described in the above embodiment, and various modification examples can be applied.

For example, the example in which the image processing apparatus 2 including an MFP or the like functions as a character recognition apparatus that performs character recognition processing using AI has been described in the above embodiment. However, the character recognition apparatus may be implemented as an apparatus different from the image processing apparatus 2. In the above-described embodiment, as an example, the case where the character recognition unit 30 performs the character recognition process on the image data generated by the scanner 3 has been described. However, the image data on which the character recognition unit 30 performs the character recognition process is not necessarily limited to the image data generated by the scanner 3 and may be image data generated by another device.

In the above-described embodiment, an example in which the information processing apparatus 1 configured of a personal computer or the like functions as the learning image generation apparatus 5 has been described. However, the learning image generation apparatus 5 is not necessarily implemented by the information processing apparatus 1 such as a personal computer. For example, the learning image generation apparatus 5 may function in the image processing apparatus 2 constituted by an MFP or the like or may function in another information device. Further, the learning image generation apparatus 5 may be configured integrally with a character recognition apparatus that performs character recognition processing using AI.

Furthermore, the above-described embodiment illustrates the case where the program 17 to be executed by the CPU 15 of the control unit 10 in the learning image generation apparatus 5 is previously stored in the storage unit 14. However, the present invention is not limited thereto, and the program 17 may be recorded in an external computer readable recording medium. Further, the program 17 may be installed in the information processing apparatus 1 via a network such as the Internet.

What is claimed is:

1. A learning image generation apparatus comprising:
a first image generating unit configured to receive a known character string and generate a first image including the character string;
a second image generating unit configured to generate a second image to be combined with the first image;
an image combining unit configured to combine the first image and the second image to generate a learning image; and
an outputting unit configured to output the learning image and correct answer data of the character string.

2. The learning image generation apparatus according to claim 1, wherein
the first image generating unit generates the first image by converting the character string into image data.

3. The learning image generation apparatus according to claim 2, wherein
the outputting unit outputs text data representing the character string as the correct answer data.

4. The learning image generation apparatus according to claim 3, wherein
the first image generating unit generates M (where M is a natural number equal to or greater than 2) first images by performing different processing on the character string when converting the character string into the image data, and
the second image generating unit generates at least M learning images by combining the second image with each of the M first images.

5. The learning image generation apparatus according to claim 1, wherein
the second image generating unit generates the second image including the seal impression image obtained by processing the character string, and
the image combining unit generates the learning image in which the seal impression image included in the second image is superimposed and combined on the character string included in the first image.

6. The learning image generation apparatus according to claim 1, wherein
the second image generating unit generates the second image including a ruled line or a frame line to be combined with the character string included in the first image or the periphery of the character string included in the first image.

7. The learning image generation apparatus according to claim 1, wherein
the second image generating unit generates the second image including a noise component.

8. The learning image generation apparatus according to claim 1, wherein
the second image generating unit generates the second image including a color image.

9. The learning image generation apparatus according to claim 1, wherein
the second image generating unit generates the second image including a character string different from the character string.

10. The learning image generation apparatus according to claim 1, wherein
the second image generating unit generates the second image including an image obtained by horizontally inverting a character string different from the character string.

11. The learning image generation apparatus according to claim 1, wherein
the image combining unit generates a plurality of learning images by changing a parameter in a case where the first image and the second image are combined, and
the outputting unit outputs the plurality of the learning images.

12. The learning image generation apparatus according to claim 11, wherein
the parameter includes a transparency of each of the first image and the second image.

13. The learning image generation apparatus according to claim 11, wherein
the parameter includes a combined position of the second image with respect to the first image.

14. The learning image generation apparatus according to claim 11, wherein
the parameter includes an arrangement angle of the second image with respect to the first image.

15. The learning image generation apparatus according to claim 11, wherein
the parameter includes distortion with respect to at least one of the first image and the second image.

16. A learning image generation method comprising:
inputting a known character string;
generating a first image including the character string;
generating a second image to be combined with the first image;
generating a learning image by combining the first image and the second image; and
outputting the learning image and a correct answer data of the character string.

17. A non-transitory computer-readable recording medium storing a computer-readable program to be executed by a hardware processor in a computer, the computer-readable program causing the hardware processor to execute processing including:
inputting a known character string;
generating a first image including the character string;
generating a second image to be combined with the first image;
generating a learning image by combining the first image and the second image; and
outputting the learning image and a correct answer data of the character string.
